(19) United States
(12) Patent Application Publication
(10) Pub. No.: US 2026/0061227 A1
(43) Pub. Date: Mar. 5, 2026

(54) PORTABLE SENSOR-DRIVEN DEVICE FOR MONITORING, ASSESSING, AND REPORTING RESPIRATOR PERFORMANCE IN REAL TIME

(71) Applicant: University of Cincinnati, Cincinnati, OH (US)

(72) Inventors: Jun Wang, Mason, OH (US); Tao Li, Mason, OH (US); Michael Yermakov, Mason, OH (US); Sergey Grinshpun, Cincinnati, OH (US); Chandrashekhar Choudhary, Cincinnati, OH (US); Xinyi NIU, Cincinnati, OH (US); Tianshuo Wang, Cincinnati, OH (US); Shantanu Ravl Dafe, Cincinnati, OH (US)

(21) Appl. No.: 19/313,122

(22) Filed: Aug. 28, 2025

Related U.S. Application Data
(60) Provisional application No. 63/688,263, filed on Aug. 28, 2024.

(51) Int. Cl. A62B 9/00

(52) U.S. Cl. CPC A62B 9/006

(57) ABSTRACT

A device for assessing particulate matter (PM) exposure in a respirator is provided. The device includes a first PM sensor, a second PM sensor, and a processor communicatively coupled to the first PM sensor and to the second PM sensor. The first PM sensor is configured to measure a PM concentration level inside of the respirator. The second PM sensor configured to measure a PM concentration level outside of the respirator. The processor is configured to determine a ratio of the PM concentration level outside the respirator and the PM concentration level inside of the respirator. The processor is further configured to determine a particulate exposure risk within the respirator based on whether the ratio satisfies at least one predetermined threshold value. The processor is further configured to provide a message indicative of the particulate exposure risk.

### RELATED APPLICATIONS

This application claims priority to U.S. Provisional Patent Application Ser. No. 63/688,263, filed Aug. 28, 2024, entitled “A Device For Better Respirator Usage and Monitoring,” the disclosure of which is hereby incorporated herein by reference, in its entirety.

### STATEMENT REGARDING FEDERALLY FUNDED RESEARCH OR DEVELOPMENT

This invention was made with government support under awarded 75D30123P17111 by the Centers for Disease Control and Prevention. The government has certain rights in the invention.

### TECHNICAL FIELD

The present invention relates to systems and methods for monitoring, assessing, and reporting particulate matter exposure levels in a respirator.

### BACKGROUND OF THE INVENTION

Inhalation exposure to particles and gases commonly occurs in the form of mist, dust, and fumes. Exposure to these particles and gases can lead to serious adverse health effects, such as metal fever, lung inflammation, silicosis, cancer, and the like. Industries such as manufacturing, construction, and mining are known to generate high concentrations of particulate matter (PM) in various shapes and sizes, ranging from nanometers to sub-millimeters. This creates a significant risk of exposure to industrial workers, as discussed, for example by Félix et al. (International Journal of Hygiene and Environmental Health, vol. 216, no. 1, pp. 17-24, 2013). Inhalable particles with aerodynamic diameters (e.g., a spherical particle) up to 100 micrometers (μm) can adversely impact human health, with different health conditions linked to varying particle sizes, as noted by Khamraev et al. (Science of the Total Environment, vol. 758, p. 143716, 2021). Smaller sized particles in respirable fractions (e.g., an aerodynamic diameter of less than 4 μm) exhibit a higher surface area, can carry a greater amount of adsorbed toxic material, and can potentially enter the systemic circulation of the body, making these smaller particles more life-threatening than larger particles. Particle exposure has been associated with chronic obstructive pulmonary disease, acute lower respiratory illness, and lung cancer (Wippich et al., Annals of Work Exposures and Health, vol. 64, no. 4, pp. 430-444, 2020). Toxic metals such as chromium (Cr) and nickel (Ni), which are present in metal fabrication industries, are recognized carcinogens. Furthermore, silicosis, an irreversible lung injury, has been linked to respirable crystalline silica present in jobs involving the use of silica-containing materials (Khamraev et al., 2021).

The risk associated with occupational health hazards can be minimized by adhering to the guidelines on allowable exposure limits issued by regulatory bodies. For example, the Occupational Safety and Health Administration (OSHA) recommends containment of emissions at the source, such as by employing engineering controls, and the use of respirators only when such controls are not feasible or appropriate. However, these guidelines and regulations are frequently violated in the workplace. For example, from October 2023 to September 2024, OSHA reported 2,694 citations under the Respiratory Protection Standard (OSHA Technical Manual, Section VIII, Chapter 2: Respiratory Protection). Ensuring proper respirator fit is also a major concern. If a respirator is not fitted properly or is loose, worker safety can be compromised. For example, Lam et al. (Journal of Hospital Infection, vol. 77, no. 3, pp. 252-256, 2011) found that a compromised N95 respirator allows approximately 33% aerosol penetration compared to approximately 4% penetration for a properly fitted N95 respirator. OSHA compliance mandates annual respirator fit testing. However, in between yearly fit tests, workers typically self-assess the respirator for leaks, which has been shown to be unreliable (P. P. Equipment, “How to implement and manage an effective respirator fit testing,” pp. 1-14).

Current methods for quantitative fit testing (QNFT) of respirators are based on either aerosol measurement instruments (e.g., TSI PortaCount) or controlled negative pressure measurement instruments (e.g., QuantiFit2) (Goko et al., International Journal of Nursing Sciences, vol. 10, no. 4, pp. 568-578, 2023; Manganyi et al., Annals of Work Exposures and Health, vol. 61, no. 9, pp. 1154-1162, 2017). These commercial products are expensive, lack portability, and cannot be used for real-time monitoring of respirator fit. Some attempts have been made to innovate in the real-time respirator leak detection space. For example, Liu et al. (IEEE Transactions on Industry Applications, vol. 54, no. 4, pp. 3928-3933, 2018) developed a prototype named ReSIM for real-time leak detection using low-cost optical particle counter (OPC) sensors to sample from inside and outside of the respirator. However, ReSIM is limited to leak detection and cannot provide fit factor values. Additionally, ReSIM faces issues with moisture condensation on the sensor, even with a moisture trap (Liu et al.; Leppänen et al., Journal of Occupational and Environmental Hygiene, vol. 15, no. 8, pp. 607-615, 2018).

Moisture condensation is a well-known problem for systems that sample exhaled breath. For example, a commercial OPC-based fit tester, the MT-05U from Sibata Scientific Technology, employs an inline heater to remove moisture but still recommends purging the sampling tubes if water droplets are observed (“Sibata Scientific Technology Ltd., Mask Fitting Tester MT-05U, specifications include tube heating and dryer mechanisms to resist condensation, dual-side particle counting for leak and fit factor evaluation, and operation compliant with JIS T 8150:2021.”. Addressing the moisture issue is crucial for any real-time fit factor measurement system because moisture can compromise sensor accuracy. Limited efforts have also been made using infrared images or speech data from acoustic sensors combined with machine learning algorithms to estimate fit factor (Brown and Vaughan, American Industrial Hygiene Association Journal, vol. 54, no. 8, pp. 409-416, 1993; Chen et al., “Poster: Noninvasive Respirator Fit Factor Inference by Semi-Supervised Learning,” 2023; Chapman et al., IEEE Open Journal of Engineering in Medicine and Biology, vol. 5, pp. 198-204, 2024; Nano et al., “Novel Smart N95 Filtering Facepiece Respirator with Real-time Adaptive Fit Functionality and Wireless Humidity Monitoring for Enhanced Wearable Comfort,” pp. 1-28). However, these approaches suffer from limitations such as having a narrow fit factor range, inapplicability for continuous real-time monitoring, and lack of verification in field applications.

It is an object of the present invention to overcome one or more of the problems described above.

### SUMMARY

In an aspect of the invention, a device for assessing particulate matter (PM) exposure in a respirator is provided. The device includes a first PM sensor, a second PM sensor, and a processor communicatively coupled to the first PM sensor and to the second PM sensor. The first PM sensor is configured to measure a PM concentration level inside of the respirator. The second PM sensor is configured to measure a PM concentration level outside of the respirator. The processor is configured to determine a ratio of the PM concentration level outside the respirator and the PM concentration level inside of the respirator. The processor is further configured to determine a particulate exposure risk within the respirator based on whether the ratio satisfies at least one predetermined threshold value. The processor is further configured to provide a message indicative of the particulate exposure risk.

In an embodiment of the invention, the device further includes a first airflow generator configured to provide airflow through a sensing region of the first PM sensor and a second airflow generator configured to provide airflow through a sensing region of the second PM sensor.

In another embodiment of the invention, the device further includes a first port fluidly coupled to the first airflow generator. The first port is configured to receive a first sampling tube connected to the respirator such that the first airflow generator directs air from the respirator through the sensing region of the first PM sensor. The device further includes a second port fluidly coupled to the second airflow generator. The second port is configured to receive a second sampling tube with an end that is open to an environment external to the respirator such that the second airflow generator directs air from the environment through the sensing region of the second PM sensor.

In another embodiment of the invention, the at least one predetermined threshold value includes an upper bound threshold value and a lower bound threshold value. In this embodiment, the particulate exposure risk is determined based on whether the ratio of the PM concentration level inside the respirator and the PM concentration level outside of the respirator is: (i) above the upper bound threshold value, (ii) between the upper bound threshold value and the lower bound threshold value, or (iii) below the lower bound threshold value.

In another embodiment of the invention, the device further includes a user interface configured to display at least one of: a protection factor value indicative of the ratio of the PM concentration level outside the respirator and the PM concentration level inside of the respirator, a representation of the particulate exposure risk, and an alert associated with a protection status of the respirator.

In another embodiment of the invention, the device further includes a third PM sensor configured to measure an ambient PM concentration level in an environment surrounding the respirator.

In another embodiment of the invention, the processor is further configured to compare the ambient PM concentration level with the PM concentration levels measured inside and outside the respirator, respectively, and to generate contextual information based on said comparison. The contextual information includes at least one of: an indication of workplace air quality, an adjustment to the particulate exposure risk determined for the respirator, and data for tracking long-term exposure trends.

In another embodiment of the invention, the message indicative of the particulate exposure risk includes at least one of: a visible alert on a touchscreen user interface, an audible alarm, or a notification transmitted to a remote device.

In another embodiment of the invention, the processor is further configured to communicate wirelessly with another device over a network, the other device being configured to display the message indicative of the particulate exposure risk.

In another aspect of the invention, a method for assessing particulate matter (PM) exposure in a respirator is provided. The method includes measuring, by a first PM sensor of a device, a PM concentration level inside of the respirator. The method further includes measuring, by a second PM sensor of the device, a PM concentration level outside of the respirator. The method further includes determining, by a processor of the device, a ratio of the PM concentration level outside the respirator and the PM concentration level inside of the respirator. The method further includes determining, by the processor, a particulate exposure risk within the respirator based on whether the ratio satisfies at least one predetermined threshold value. The method further includes providing, by the processor, a message indicative of the particulate exposure risk.

In an embodiment of the invention, the method includes determining the particulate exposure risk by comparing the ratio with an upper bound threshold value and a lower bound threshold value, and determining the particulate exposure risk based on whether the ratio is: (i) above the upper bound threshold value, (ii) between the upper bound threshold value and the lower bound threshold value, or (iii) below the lower bound threshold value.

In another embodiment of the invention, the method further includes receiving, by a third PM sensor of the device, an ambient PM concentration level in an environment surrounding the respirator, and generating, by the processor of the device, contextual information based on a comparison of the ambient PM concentration level with the PM concentration levels measured inside and outside of the respirator, respectively. The contextual information includes at least one of: an indication of workplace air quality, an adjustment to the particulate exposure risk, and data for tracking long-term exposure trends.

In another embodiment of the invention, the method further includes directing, by a first airflow generator of the device, air from inside the respirator through a sensing region of the first PM sensor, and directing, by a second airflow generator, air from an environment external to the respirator through a sensing region of the second PM sensor.

In another embodiment of the invention, the method further includes regulating, by the processor, an airflow rate of at least one of the first airflow generator and the second airflow generator by providing a pulse width modulation (PWM) control signal based on a measured flow rate and a configured flow rate.

In another embodiment of the invention, the method of regulating the airflow rate further includes generating, by the processor, a control signal corresponding to a duty cycle for the airflow generator. The method further includes receiving, by the processor, a feedback signal indicative of a rotational speed or airflow rate. The method further includes determining, by the processor, an error value as a difference between the configured flow rate and the measured flow rate. The method further includes updating, by the processor, the duty cycle of the control signal based on the error value.

In another embodiment of the invention, the method further includes removing, by a semi-permeable membrane tube disposed along a sampling tube coupled to the respirator, water from air collected from inside of the respirator prior to measurement by the first PM sensor.

In another embodiment of the invention, the method includes that the message indicative of the particulate exposure risk includes at least one of: a visible alert on a touchscreen user interface, an audible alarm, or a notification transmitted to a remote device.

In another aspect of the invention, an exposure protection system is provided. The exposure protection system includes a respirator, a device adapted to assess particulate matter (PM) exposure in the respirator, a first sampling tube connecting the first PM sensor with the respirator, and a second sampling tube connecting the second PM sensor with environment external to the respirator. The device includes a first PM sensor configured to measure a PM concentration level inside of the respirator, a second PM sensor configured to measure a PM concentration level outside of the respirator, and a processor communicatively coupled to the first PM sensor and to the second PM sensor. The processor is configured to determine a ratio of the PM concentration level outside the respirator and the PM concentration level inside of the respirator. The processor is further configured to determine a particulate exposure risk within the respirator based on whether the ratio satisfies at least one predetermined threshold value. The processor is further configured to provide a message indicative of the particulate exposure risk.

In an embodiment of the invention, a portion of the first sampling tube includes a semi-permeable membrane tube adapted to remove water vapor from exhaled air before the air reaches the first PM sensor.

In another embodiment of the invention, the processor is further configured to communicate wirelessly with another device over a network, the other device being configured to display the message indicative of the particulate exposure risk.

The above summary presents a simplified overview of some embodiments of the invention to provide a basic understanding of certain aspects of the invention discussed herein. The summary is not intended to provide an extensive overview of the invention, nor is it intended to identify any key or critical elements or delineate the scope of the invention. The sole purpose of the summary is merely to present some concepts in a simplified form as an introduction to the detailed description presented below.

### BRIEF DESCRIPTION OF THE DRAWINGS

The objects and advantages of the invention disclosed will be further appreciated in light of the following detailed descriptions and drawings in which:

FIG. 1 is a diagram that illustrates an exposure protection system that includes a particulate matter (PM) exposure assessment device, sampling tubes, and a respirator, where the PM exposure assessment device is capable of communicating with one or more other devices over a network.

FIG. 2 is a block diagram of the example hardware components of the PM exposure assessment device.

FIG. 3 is a block diagram of an example circuit architecture for the PM exposure assessment device.

FIG. 4A is a block diagram of an example control system for regulating operation of an airflow generator in a closed-loop configuration.

FIG. 4B is a flowchart of a method for regulating operation of the airflow generator in the closed-loop configuration.

FIG. 5A is an exploded view of the PM exposure assessment device which is housed within a casing that includes a top portion and a bottom portion.

FIG. 5B is an interior view of the top and bottom portions of the casing of the PM exposure assessment device.

FIG. 6 is an assembled view of the PM exposure assessment device housed within the casing.

FIG. 7 shows an example software system architecture for the PM exposure assessment device.

FIG. 8A is a diagram of example pages of an exposure assessment application.

FIG. 8B is an example state diagram corresponding to a first mode or page of the exposure assessment application (e.g., an “easy” mode or “easy” mode page).

FIG. 8C is an example state diagram corresponding to a second mode or page of the exposure assessment application (e.g., an “expert” mode or “expert” mode page).

FIG. 9A is an example user interface corresponding to the first mode of the exposure assessment application.

FIG. 9B is another example user interface corresponding to the first mode of the exposure assessment application.

FIG. 9C is another example user interface corresponding to the first mode of the exposure assessment application.

FIG. 9D is an example user interface corresponding to the second mode of the exposure assessment application.

FIG. 9E is an example user interface corresponding to a settings page of the exposure assessment application.

FIG. 9F is an example user interface corresponding to an informational page of the exposure assessment application.

FIG. 10 is a graph comparing total PM concentration levels measured by a PM sensor of the PM exposure assessment device with concentration levels measured by a reference optical particle sizing instrument, plotted against concentration levels measured by a reference condensation particle counter.

FIG. 11 is a set of graphs illustrating an example current consumption profile of the PM exposure assessment device, including a complete current profile during operation and a transient startup current profile showing initial current spikes.

FIG. 12 is a graph illustrating an example thermal profile of the PM exposure assessment device during continuous operation, including temperature measurements recorded over time for multiple internal components using thermocouple probes and infrared (IR) thermal imaging.

FIG. 13A is a schematic diagram illustrating an example operating principle of a semi-permeable membrane tube (e.g., a Nafion dryer) for selectively removing water vapor from exhaled breath.

FIG. 13B is a schematic diagram of an example test configuration for evaluating the effectiveness of the semi-permeable membrane tube, showing a respirator, an upstream humidity sensor, a downstream humidity sensor, the semi-permeable membrane tube, and the PM exposure assessment device.

FIG. 13C is a graph illustrating measured humidity and temperature profiles from the upstream humidity sensor and the downstream humidity sensor during extended operation with the semi-permeable membrane tube.

FIG. 13D is a graph comparing particle concentration readings obtained using regular tubing versus using the semi-permeable membrane tube, demonstrating the effectiveness of the Nafion dryer in reducing condensation-related anomalies and extending device runtime.

FIG. 14 is a graph illustrating a comparison between fit factor values measured by the PM exposure assessment device and fit factor values measured by a commercially available quantitative fit testing device (e.g., a reference PortaCount® system), where each data point represents a paired measurement obtained simultaneously by both devices to demonstrate the correlation between the two sets of fit factor values.

FIG. 15 is a graph illustrating PM concentration data recorded by a PM sensor of the PM exposure assessment device during a test involving a human subject wearing a respirator and performing random coughing.

### DETAILED DESCRIPTION OF THE INVENTION

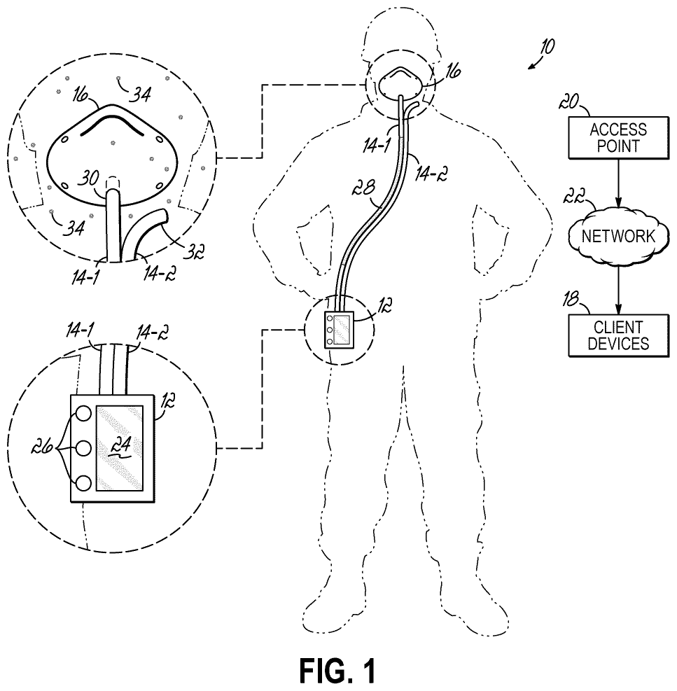

FIG. 1 is a diagram that illustrates an exposure protection system 10 that includes a particulate matter (PM) exposure assessment device 12, sampling tubes 14-1 and 14-2, and a respirator 16, where the PM exposure assessment device 12 is capable of communicating with one or more other devices (e.g., one or more client devices 18, access point 20, etc.) over a network 22. As used herein, the term ‘particulate matter’ (PM) refers to airborne particles, including dust, smoke, aerosols, and/or any other inhalable and/or respirable particulates.

The PM exposure assessment device 12 (sometimes referred to herein as a “device” or a “device for assessing PM exposure in a respirator”) includes one or more sensor devices configured to detect PM both inside and outside of the respirator 16. For example, the PM exposure assessment device 12 may include a set of PM sensor devices, such as optical particle counters, gravimetric sensors, laser-based light scattering sensors, photometric PM sensors, and/or any other sensor device capable of measuring PM concentration levels inside and outside of the respirator 16. In some embodiments, the PM exposure assessment device 12 may include a first PM sensor configured to measure a PM concentration level inside of the respirator 16 and a second PM sensor configured to measure a PM concentration level outside of the respirator 16.

In some embodiments, the PM exposure assessment device 12 may further include a third PM sensor configured to monitor an ambient PM concentration level in the surrounding environment. The third PM sensor may be used to provide contextual information relating to air quality of the surrounding environment. As will be described further herein, the measured ambient PM concentration level may be compared against PM concentration levels measured inside and outside the respirator 16, and/or may be used to generate a baseline exposure profile for a given location. The contextual information may be stored locally or transmitted via the network 22 to facilitate long-term exposure tracking and compliance reporting.

The PM exposure assessment device 12 further includes one or more components capable of receiving, processing, storing, transmitting, and/or displaying information associated with an assessment of a particulate exposure risk within the respirator 16. In some embodiments, the PM exposure assessment device 12 may include a processor, such as a single-board computer (e.g., a Raspberry Pi), a microprocessor, a microcontroller, a digital signal processor (DSP), and/or the like. The processor may execute instructions to determine a protection factor value, to evaluate whether the protection factor value satisfies one or more predetermined threshold values, and/or to generate a message or alert when the respirator 16 is determined to leak or is providing insufficient protection. As used herein, the term “protection factor” refers to a ratio of the PM concentration level outside the respirator 16 and the PM concentration level inside of the respirator 16.

In some embodiments, the PM exposure assessment device 12 may also include a user interface 24. The user interface 24 may include a touchscreen (e.g., a 3.5-inch screen) configured to display PM concentration levels, protection factor values, particle exposure risk levels, and/or the like. In some embodiments, the user interface 24 may also be configured to display audible and/or visual alarms 26 that indicate when the protection factor is below a minimum acceptable threshold, thereby notifying the wearer of a potential leak. In some embodiments, the user interface 24 may further provide status information regarding system operation, battery life, network connectivity, and historical exposure data.

The sampling tubes 14-1 and 14-2 may include conduits that permit airflow between the respirator 16, the external environment, and the PM exposure assessment device 12. For example, sampling tube 14-1 may be configured to sample exhaled air from inside the respirator 16 and sampling tube 14-2 may be configured to sample air from an environment external to the respirator 16.

In some embodiments, a middle portion of the sampling tube 14-1 may include a semi-permeable membrane tube 28 configured to selectively remove water vapor from air traversing the tube. In one embodiment, the semi-permeable membrane tube 28 may be a Nafion dryer. Nafion is a polymer that incorporates sulfonic acid groups (—SO₃H) along fluorocarbon side chains which function as highly selective channels for water vapor transport. When a humidity gradient exists across the Nafion membrane, water vapor is absorbed from the humid air stream inside the sampling tube and diffuses across the membrane until equilibrium is reached, thereby reducing condensation inside the tube. By maintaining a lower humidity level in the airflow entering the PM sensor 14-1, the Nafion dryer prevents or reduces the likelihood of high particle concentration readings caused by the accumulation of moisture or other contaminants in the sensing region or associated airflow pathway.

The respirator 16 includes any type of personal protective equipment (PPE) designed to protect a respiratory system of a wearer from an airborne hazard. For example, respirator 16 may be a filtering facepiece respirator (FFR), such as an N95 respirator, a powered air-purifying respirator (PAPR) with a half-mask or full-face mask, a supplied-air respirator (SAR) with a half-mask or full-face mask, a self-contained breathing apparatus (SCBA) with a full-face mask, or any other type of PPE that covers the wearer's face or nose and mouth to limit particle ingress. As shown in FIG. 1, an endpoint 30 of the sampling tube 14-1 connects to an interior cavity of the respirator 16, while an endpoint 32 of the sampling tube 14-2 is open to an environment external to the respirator. Each sampling tube 14-1, 14-2 has an opposing endpoint connected to the PM exposure assessment device 12. FIG. 1 also illustrates example particles 34 that may accumulate within respirator 16 during use, representing inhalable or respirable PM that can pose health risks to the wearer.

Each client device 18 is configured to communicate with the PM exposure assessment device 12 to receive information associated with a particulate exposure risk. For example, a client device 18 may be a mobile phone (e.g., a smartphone), a tablet computer (e.g., an iPad), a laptop computer, a desktop computer, a server computer, a wearable device (e.g., a smartwatch, a pair of smart eyeglasses), a gaming device, or other communication-capable hardware. In some embodiments, the client device 18 may execute a web-based or dedicated application configured to display PM concentration levels, historical exposure data, and/or alerts generated by the PM exposure assessment device 12.

Access point 20 includes one or more components configured to provide network connectivity between the PM exposure assessment device 12 and the network 22. For example, the access point 20 may be a Wi-Fi router, a cellular base station, a mesh network node, and/or another wireless access device capable of establishing communication with the PM exposure assessment device 12.

Network 22 may include one or more wired and/or wireless networks. For example, network 22 may include a cellular network (e.g., a fifth generation (5G) network, a fourth generation (4G) network, such as a long-term evolution (LTE) network, a third generation (3G) network, and/or a code division multiple access (CDMA) network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

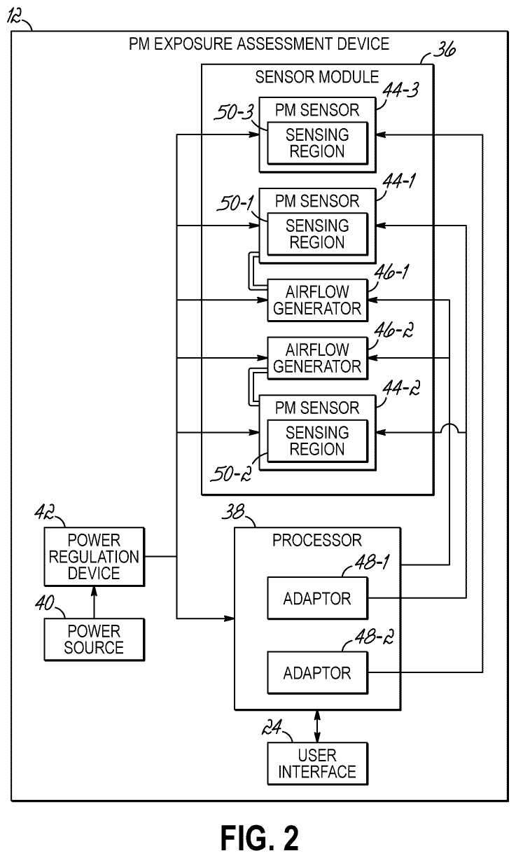

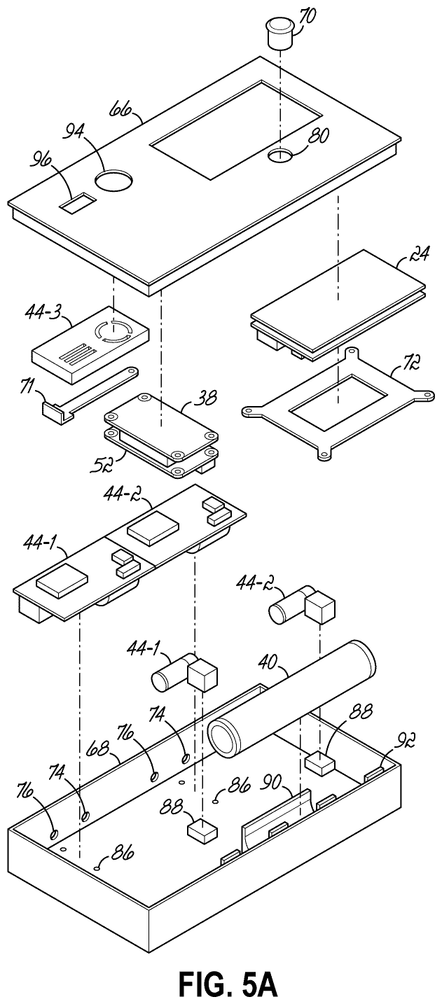

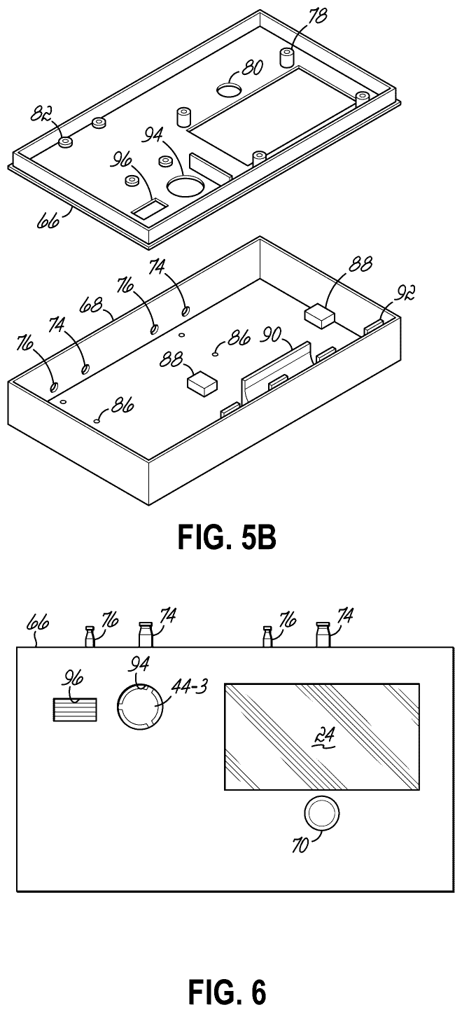

FIG. 2 shows a block diagram of the example hardware components of the PM exposure assessment device 12. For example, the PM exposure assessment device 12 may include a sensor module 36, a processor 38, a power source 40, a power regulation device 42, and a user interface 24, each of which may be integrated together in a package suitable for wearable applications. In some embodiments, these components may be housed in a custom-built 3-D printed enclosure, such as that shown and described in connection with FIGS. 5A and 5B and FIG. 6.

The sensor module 36 may include a plurality of PM sensors and one or more airflow generators. In the example shown in FIG. 2, the sensor module 36 includes PM sensors 44-1, 44-2, and 44-3, and airflow generators 46-1, 46-2. In some embodiments, PM sensors 44-1 and 44-2 may be PM sensors of the same type, such as a PMS-11 optical particle counter manufactured by Temtop. In this embodiment, PM sensor 44-1 may be configured to measure a PM concentration level inside of the respirator 16 and PM sensor 44-2 may be configured to measure a PM concentration level outside of the respirator 16. The dimensions of the PM sensors 44-2, 44-2 may vary by embodiment, but in some cases, such as when a PMS-11 sensor is used, the sensor may have a height of 113 millimeters (mm), a width of 88 mm, and a depth or thickness of 10 mm. Comparatively, PM sensor 44-3 may include a different type of optical particle counter (e.g., a PMS-900M manufactured by Temtop) which may be configured to monitor general PM concentration levels in a workplace environment due to having a relatively wide measurement range and compact form factor. The dimensions of the PM sensor 44-3 may vary by embodiment, but in some cases, such as when a PM-900M sensor is used, the sensor may have a height of 50 mm, a width of 42.7 mm, and a depth of 10 mm.

Each of PM sensors 44-1, 44-2, and 44-3 may operate on the principle of Mie scattering which is the process whereby light waves interact with particles that are comparable in size to their wavelength, resulting in a scattered pattern where most light is scattered forward. Each PM sensor 44 may include a corresponding sensing region 50. This is shown in FIG. 2, where PM sensor 44-1 has a sensing region 50-1, PM sensor 44-2 has a sensing region 50-2, and PM sensor 44-3 has a sensing region 50-3.

Air flow generators 46-1 and 46-2 may be used to deliver air samples to PM sensors 44-1 and 44-2, respectively. In some embodiments, each air flow generator 46 may include a miniature pump (e.g., a model D260BLX-V from TCS) selected for having a reduced form factor and relatively low power consumption. Such miniature pumps may be used in place of the original pumps supplied with PMS-11 sensors, which are relatively bulky and consume more power, thereby making them unsuitable for wearable operation. Each air flow generator 46 may draw air from a respective location (e.g., inside the respirator or outside the respirator) via tubing and deliver the air to a sensing region or chamber of the corresponding PM sensor 44.

The processor 38 may include one or more computing devices configured to receive, process, and store data from the PM sensors 44. In some embodiments, processor 38 may be a Raspberry Pi (e.g., a Raspberry Pi Zero (RPi0)) which provides sufficient computational resources for data collection and analysis while maintaining a compact form factor and low power consumption. The processor 38 may also interface with a network for remote monitoring and data storage.

In some embodiments, the processor 38 may receive, from PM sensor 44-1, a measurement of a PM concentration level inside of the respirator 16. The processor 38 may also receive, from PM sensor 44-2, a measurement of a PM concentration level outside of the respirator 16. In this case, the processor 38 may be configured to determine a protection factor value which represents a ratio of the PM concentration level outside the respirator 16 and the PM concentration level inside of the respirator 16.

In some embodiments, the processor 38 may receive, from PM sensor 44-3, a measurement of an ambient PM concentration level in an environment surrounding the respirator 16. In this case, the processor 38 may generate contextual information based on a comparison of the ambient PM concentration level with the PM concentration levels measured inside and outside of the respirator, respectively. The contextual information may include information indicative of environmental air quality conditions, information indicative of relative particle exposure risks, information indicative of historical workplace exposure trends, and/or the like.

To accommodate communication with multiple PM sensors 44, the processor 38 may be coupled to one or more adapters, such as adapters 48-1, 48-2. Adapter 48-1 may, for example, be an RS485-UART adapter and adapter 48-2 may, for example, be an Inter-Integrated Circuit (I²C)-UART adapter.

The processor 38 may communicate with PM sensors 44-1 and 44-2 via an interface provided through the adapter 48-1. For example, the processor 38 may communicate with PM sensors 44-1 and 44-2 via an RS485 interface provided through the RS485-UART adapter. The RS485 interface may provide a half-duplex communication protocol with high input impedance, thereby enabling multiple devices to be connected to the same communication line. PM sensor 44-3 may communicate with the processor 38 via another interface provided through the adapter 48-2. For example, PM sensor 44-3 (e.g., the PMS-900M) may communicate with the processor 38 via a UART interface provided through the I²C-UART adapter. As would be understood by one of ordinary skill in the art, other types of adapters and/or interfaces may be implemented.

In some embodiments, the processor 38 may generate pulse-width modulation (PWM) signals that are provided to the air flow generators 46-1, 46-2. These PWM signals may control the operation of the air flow generators 46-1, 46-2 to regulate airflow rates delivered to PM sensors 44-1 and 44-2, respectively.

The user interface 24 may include a touchscreen display. The user interface 24 may be a 3.5-inch screen or another type of screen suitable to the needs of a particular user. The user interface 24 may be configured to display information relating to particulate exposure risk to a user, such as by displaying PM concentration levels, system status information, exposure alerts, and/or the like. In some embodiments, the user interface 24 may include a buzzer capable of providing an audible alert in the event that a particulate exposure risk is detected.

As used herein, the term “particulate exposure risk” refers to an assessment of the likelihood that a wearer of the respirator is being exposed to hazardous levels of particulate matter. In some embodiments, the particulate exposure risk is defined by comparing a ratio of the particle concentration level inside the respirator to the particle concentration level outside the respirator against one or more predetermined threshold values. The particulate exposure risk may correspond to a categorical risk level (e.g., safe, cautionary, unsafe) or a continuous measure based on how the computed ratio relates to one or more configured threshold values.

The power source 40 may include a rechargeable battery configured to supply electrical energy for wearable operation of the PM exposure assessment device 12. The power regulation circuit 42 may include circuitry configured to regulate the voltage and current supplied from the power source 40 to the various components of the PM exposure assessment device 12. In some embodiments, the power source 40 may be operatively coupled to the power regulation circuit 42 via a direct current (DC) connection. The power regulation circuit 42 may distribute regulated power to each of the PM sensors 44, the air flow generators 46, and the processor 38 to support operation of the device.

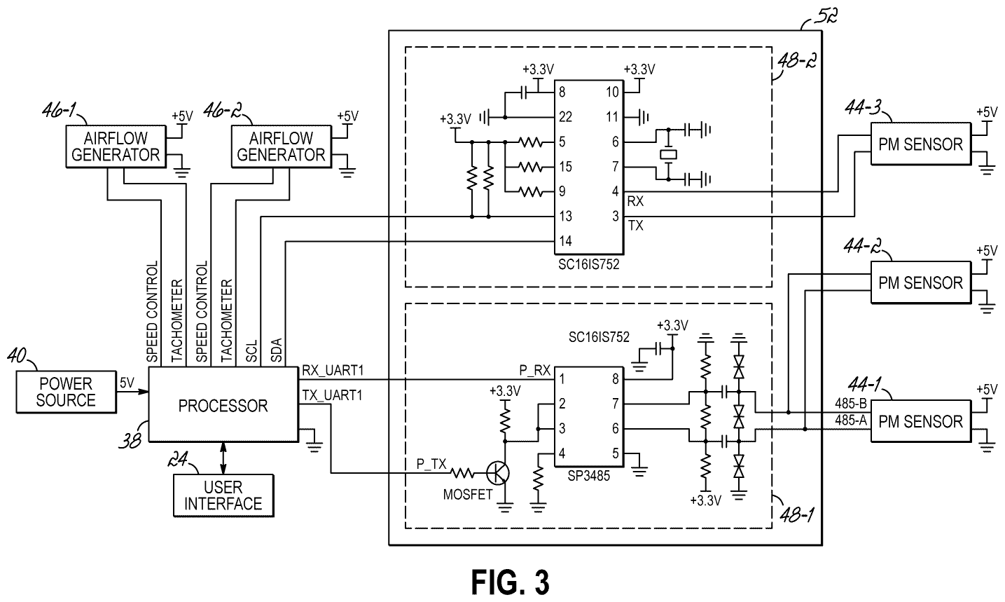

FIG. 3 illustrates an example circuit architecture for the PM exposure assessment device 12. The PM exposure assessment device 12 includes a power source 40 that is configured to provide electrical power to the processor 38. The processor 38 serves as the central control unit and is configured to interface with other components, including the user interface 24, airflow generators 46-1 and 46-2, and PM sensors 44-1, 44-2, and 44-3. In some embodiments, the processor 38 may be implemented using a Raspberry Pi Zero, although other processors with similar functionality may also be used.

In some embodiments, PM sensors 44-1 and 44-2 may each be PMS-11 type sensors, while PM sensor 44-3 may be a PM-900M type sensor. Communication between the processor 38 and the PM sensors is facilitated by interface adapters 48-1 and 48-2, which may be implemented on a printed circuit board (PCB) 52. In some embodiments, adapter 48-1 may be an RS485-UART adapter that enables communication between the processor 38 and PM sensors 44-1 and 44-2. In some embodiments, adapter 48-2 may be an I²C-UART adapter that enables communication between the processor 38 and PM sensor 44-3.

In some embodiments, the processor 38 may communicate with adapter 48-1 using one or more Universal Asynchronous Receiver/Transmitter (UART) lines. In this case, adapter 48-1 may convert the UART signals to RS-485 signals for communication with PM sensors 44-1 and 44-2. To provide a specific example, adapter 48-1 may include a half-duplex RS-485 transceiver, such as an SP3485 chip, that is configured to convert UART single-ended signals (TX, RX) into RS-485 differential signals (485_A, 485_B) and vice versa. Adapter 48-1 may include a control stage for direction switching, such as a metal-oxide-semiconductor field-effect transistor (MOSFET) circuit which toggles driver-enable and receiver-enable pins of the SP3485 chip so that the bus operates in transmit mode only when data is being sent and returns to receive mode otherwise.

The adapter 48-1 may also include supporting passive and protective components, such as resistors, diodes, and capacitors. For example, pull-up and pull-down resistors may be used to maintain stable logic states at the UART input/output lines, while series resistors may be used to condition UART signals by limiting transient currents and reducing electrical noise or signal reflections. Termination resistors may be placed across RS485_A and RS485_B lines to match the characteristic impedance of the transmission line. This matching reduces unwanted signal reflections which could otherwise cause distortion or data errors at the receiver. Transient-voltage-suppression (TVS) diodes may be provided to protect the RS-485 bus from electrostatic discharge or electrical transients by clamping high voltages that could otherwise damage the SP3485 chip or the processor 38. Bypass capacitors may be connected to the voltage at the common collector (VCC) supply pin of the SP3485 chip to filter noise and stabilize the supply voltage.

In some embodiments, the processor 38 may also communicate with adapter 48-2 such as an I²C-UART adapter. The I²C-UART adapter may include a dual-channel UART with an I²C or Serial Peripheral Interface (SPI), enabling the processor 38 to control multiple UART ports despite having only one native UART port. For example, the expander may serve as a bridge between the processor 38 and PM sensor 44-3, listening for messages over the I²C bus and converting those messages to UART transmit and receive signals for communication with the PM sensor 44-3. In one embodiment, adapter 48-2 may be implemented using an SC16IS752 chip which includes pins for I²C clock and data lines, configurable address pins to allow multiple devices on the same I²C bus, transmit and receive lines for UART communication, power and ground pins for operation, and clock pins for UART timing reference.

In some embodiments, the processor 38 may also be configured to provide a control signal, such as a pulse width modulation (PWM) signal, to each airflow generator 46-1 and 46-2 to regulate airflow rates through the respective PM sensors 44-1 and 44-2. Each airflow generator 46-1 and 46-2 may also provide a feedback signal, such as a tachometer output signal, to the processor 38. The tachometer output signal may include information about the rotational speed, such as rotations per minute (RPM) or another indication of flow rate. The processor 38 may use the feedback signals to verify that the airflow generators are operating properly, to detect defects such as clogging of a sampling tube or a stalled generator, and to adjust the PWM control signal to maintain a target airflow rate.

In some embodiments, the feedback signal may be generated by an airflow generator 46 (e.g., via a tachometer output). In other embodiments, the feedback signal may be provided by any suitable flow measurement device, such as a thermal mass flow sensor, differential pressure sensor, or other inline flow monitoring element connected to the tubing or disposed within the airflow pathway of the device 12.

In some embodiments, the processor 38 may further be configured to provide output signals to the user interface 24. The processor 38 may provide video signals to a touchscreen display of the user interface 24 using a High-Definition Multimedia Interface (HDMI) or a Display Serial Interface (DSI). The touchscreen may return input signals to the processor 38 using Universal Serial Bus (USB) connections or General-Purpose Input/Output (GPIO) pins. The processor 38 may also provide feedback alerts to the user via the user interface 24, such as visual alerts displayed on the touchscreen, audible alerts produced by a buzzer or speaker, or a combination thereof, when a compromised respirator condition or elevated particle exposure risk is detected.

During operation, the processor 38 may coordinate activation of the airflow generators 46-1 and 46-2, may receive PM concentration levels data from the PM sensors 44-1, 44-2, and 44-3 through the adapters 48-1 and 48-2, and may process the data to compute protection-factor-related values. Based on those computations, the processor 38 may provide exposure-related feedback to a user through the user interface 24 and, in some embodiments, may transmit the data to external devices or systems for remote monitoring or storage.

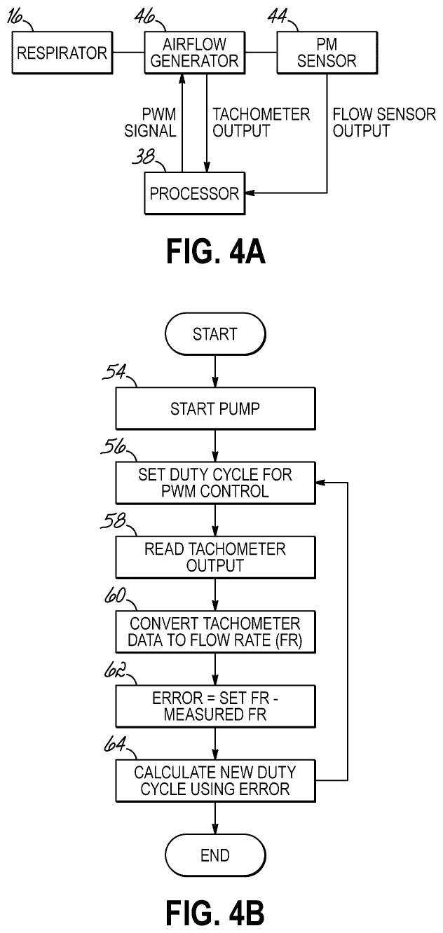

FIGS. 4A and 4B illustrate an example control system and method for regulating operation of an airflow generator 46 (e.g., a miniature pump) in a closed-loop configuration.

As shown in FIG. 4A, the airflow generator 46 is fluidly coupled between a respirator 16 and a PM sensor 44 and is configured to draw air from the respirator 16 toward the PM sensor 44. The airflow generator 46 is electrically coupled to the processor 38. The processor 38 provides a control signal to the airflow generator 46 and receives feedback signals relating to its operation. For example, the airflow generator 46 may be configured to receive a pulse width modulation (PWM) control signal from the processor 38 and to generate a tachometer output signal indicative of a rotational speed of the airflow generator 46. In some embodiments, the tachometer output may be further converted to represent an equivalent flow rate. In the example shown, the airflow generator 46 is also coupled to a PM sensor 44 that generates an output which is communicated to the processor 38 for validation or calibration purposes.

During use, the respirator 16 experiences varied pressure conditions due to sinusoidal breathing patterns of the wearer. As such, the airflow rate produced by the airflow generator 46 may fluctuate during operation. Accordingly, in some embodiments, the processor 38 may execute a closed-loop control algorithm to maintain a substantially constant average flow rate across the respirator 16 and toward the PM sensor 44.

FIG. 4B illustrates an example flowchart of such a closed-loop control algorithm. At step 54 (shown as “Start Pump”), the processor 38 initiates operation of the airflow generator 46. At step 56, the processor 38 sets an initial duty cycle for the PWM control signal to regulate the airflow generator 46. At step 58, the processor 38 receives, reads, and records the tachometer output generated by the airflow generator 46. At step 60, the processor 38 converts the tachometer output to a measured flow rate (FR) value using a predetermined relationship between tachometer output and flow rate that may be experimentally derived.

At step 62, the processor 38 computes an error value equal to the difference between a configured (e.g., expected, desired) flow rate and the measured flow rate. At step 64, the processor 38 calculates a new PWM duty cycle based on the error value. For example, the processor 38 may calculate a new PWM duty cycle by processing the error value using a proportional-integral-derivative (PID) control algorithm or another type of feedback control mechanism. The updated PWM duty cycle is then applied to the airflow generator 46 to adjust the operating speed. Steps 56-64 are repeated in a closed loop until the error is minimized or maintained below a threshold value.

By implementing the closed-loop modulation illustrated in FIGS. 4A and 4B, the PM exposure assessment device 12 may compensate for breathing-induced pressure fluctuations and may maintain consistent airflow delivery to the PM sensor 44. This reduces variability in flow rate between the inside and outside sensors and improves the accuracy and stability of protection factor calculations.

FIGS. 5A and 5B illustrate an example packaging architecture for the PM exposure assessment device 12. FIG. 5A shows an exploded view of the PM exposure assessment device 12 which includes a top case 66 and a bottom case 68, along with the processor 38 (e.g., a Raspberry Pi Zero), a PCB 52, a power switch 70, the touchscreen user interface 24, a bracket 71 corresponding to PM sensor 44-3, a screen mount 72, airflow generators 46-1, 46-2, the power source 40 (e.g., a rechargeable battery pack), and the PM sensors 44-1, 44-2 (e.g., PMS-11 sensors). The bottom case 68 further includes an inlet port 74 and an outlet port 76 to accommodate sampling tube connections to the respirator 16 and external environment. As shown, each of these components is arranged within the enclosure so that the PM exposure assessment device 12 may be deployed in a compact, wearable form factor suitable for use by a worker.

FIG. 5B shows an interior view of the top case 66 and bottom case 68, illustrating structural mounting features. For example, the top case 66 includes a touchscreen mount 78, a power switch mount 80, and a processor and PCB mount 82. The top case 66 also includes a slot or opening 94 configured to receive the PM sensor 44-3 (e.g., a PM-900M sensor). The bottom case 66 includes mounts 86 configured to receive PM sensors 44-1, 44-2 and mounts 88 configured to secure airflow generators 46-1, 46-2 (e.g., miniature pumps). The bottom case 66 also includes a slot 90 configured to receive the power source 40 and wire guides 92 configured to route electrical connections.

This packaging architecture provides several advantages over conventional quantitative fit testing devices. Existing OSHA-accepted fit testers are typically large, bench-top systems designed for laboratory or clinic use. These systems often require external cabling for power and data, making these systems unsuitable for continuous monitoring in the field. By contrast, the power source 40 is integrated directly into the housing as is shown in FIGS. 5A and 5B and the housing includes dedicated slots and mounts for all major components. This eliminates the need for external cables and enables real-time exposure assessment while being worn by a user.

Another limitation of conventional fit testers is the use of a single particle counter while requiring sequential sampling inside and outside of a respirator. As a result, continuous, real-time assessment of respirator performance in the workplace is not possible. The enclosure of FIGS. 5A and 5B is specifically configured to house multiple PM sensors 44-1, 44-2, 44-3 along with dedicated airflow generators 46-1, 46-2, allowing for simultaneous measurement of inside, outside, and ambient particle concentrations. This configuration and packaging directly supports real-time leak detection and protection factor calculations that can be performed during workplace operation, rather than only during controlled fit-testing sessions.

Additionally, conventional particle monitoring instruments often suffer from sensor drift due to thermal coupling between processors, power circuits, and sensitive optical components. The modular mounting arrangement shown in FIG. 5B separates the processor and battery from the sensor mounts 86, thereby reducing temperature variation in the sensing regions and improving long-term measurement accuracy.

The packaging design also improves serviceability and reliability. Known fit testers require specialized disassembly to replace failed pumps or sensors. By contrast, the modular mounts 78, 80, 82, 86, and 88 allow each component to be independently installed or removed, enabling quick replacement of pumps, sensors, or the processor board. The bottom case 66 further incorporates wire guides 92 to secure internal wiring, reducing strain on connectors and minimizing the risk of accidental disconnections when the PM exposure assessment device 12 is subjected to vibration or movement in industrial environments.

Finally, conventional systems or devices often require users to access separate modules for power and data feedback, complicating operation in environments where workers are already encumbered by personal protective equipment (PPE). By integrating the touchscreen mount 78 and power switch mount 80 into the top case 66, the PM exposure assessment device 12 ensures that both power control and feedback functions are accessible on a single surface. This arrangement simplifies operation, enabling workers to quickly check protection factor values or respond to alarms while in the field.

Accordingly, the mechanical integration illustrated in FIGS. 5A and 5B provides a durable, compact, and serviceable packaging for the PM exposure assessment device 12, while maintaining reliable airflow routing, consistent sensor alignment, and long-term usability in field environments such as industrial worksites.

FIG. 6 illustrates an assembled view of the PM exposure assessment device 12. In this example, the PM exposure assessment device 12 is enclosed within a housing having overall dimensions of approximately 180 mm in width, 117 mm in height, and 52 mm in depth. With these dimensions, the PM exposure assessment device 123 forms a compact, handheld or wearable form factor suitable for worker use in occupational environments.

As shown, the PM exposure assessment device 12 includes the PM sensor 44-3 (e.g., a PM-900M sensor) disposed within an opening 94 in the front face of the housing. Adjacent to this location is an opening 96 configured to provide an air intake pathway into the PM sensor 44-3. The housing further includes a set of inlets 74 and outlets 76 positioned on the top surface of the enclosure. In operation, the inlets 74 may receive airflow from one or more sampling tubes connected to the interior and/or exterior of a respirator, and the outlets 76 may exhaust sampled airflow after sampled airflow passes through the respective PM sensors 44-1, 44-2.

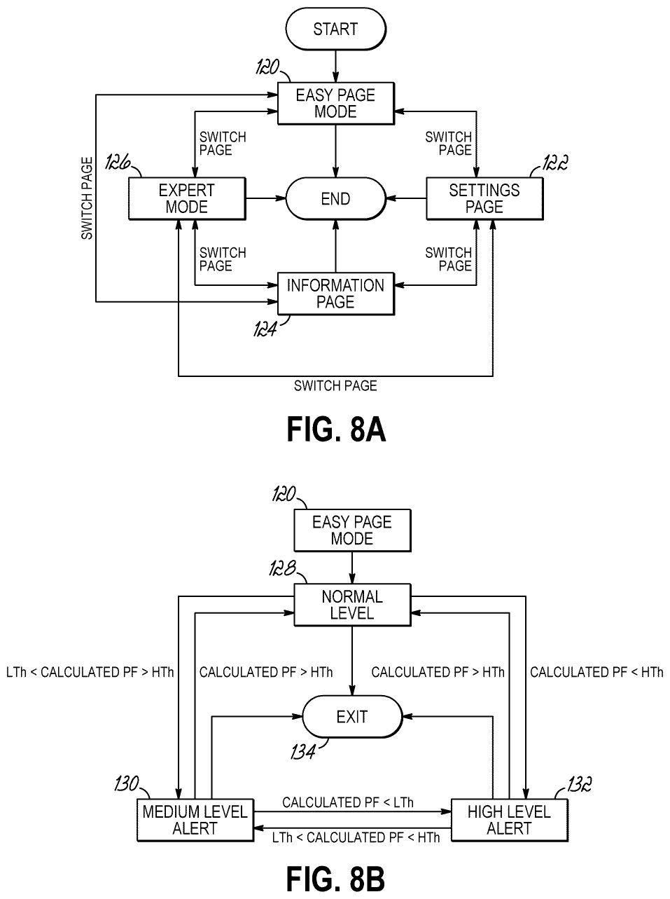

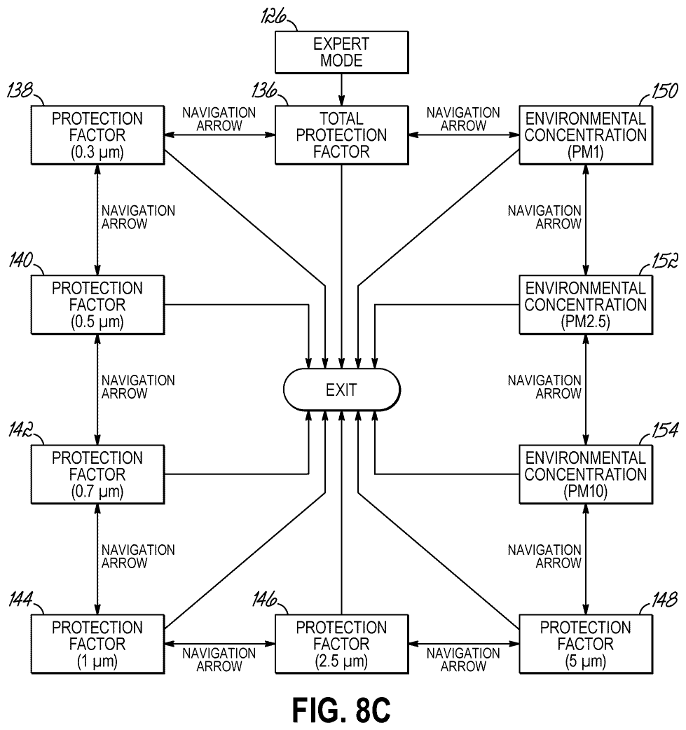

Also visible on the front surface is the user interface 24 which is shown as being implemented as a touchscreen display. In the illustrated embodiment, the user interface 24 provides information regarding a protection factor value calculated by the processor 38 based on data received from the PM sensors 44-1, 44-2, as well as qualitative information regarding environmental PM concentration levels received from PM sensor 44-3. The user interface 24 further includes selectable on-screen controls, such as an audible alarm snooze option and is capable of operating in multiple modes (e.g., “easy” mode, “expert” mode, as is shown in FIGS. 8A-8C).

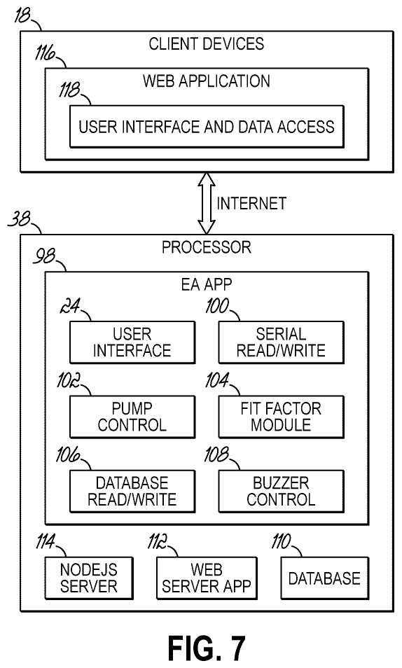

FIG. 7 shows an example software system architecture for the PM exposure assessment device 12. The example software system architecture provides two distinct user interfaces, including the local user interface 24 accessible via the PM exposure assessment device 12 and a web-based remote user interface 118 accessible via one or more client devices 18 over the network 22.

In some embodiments, the PM exposure assessment device 12 (e.g., using processor 38) may be configured to execute an exposure assessment application 98 in C++ or a similar type of programming language. The exposure assessment application 98 may permit content to be displayed via the user interface 24, such as a protection factor value indicative of a ratio of a PM concentration level inside the respirator 16 and a PM concentration level outside the respirator 16. The user interface 24 may further display contextual information relating to an indication of workplace air quality, the particular exposure risk, data for tracking long-term exposure trends, and the like. A serial read/write module 100 enables the exchange of data between the processor 38 and PM sensors 44-1, 44-2, 44-3. A pump control module 102 may be configured to regulate operation of the airflow generators 46-1, 46-2. A fit factor module 104 may be configured to compute protection factor values based on particle concentration levels measured inside and outside the respirator 16. A database read/write module 106 may be configured to store validated sensor data in a database or data structure. A buzzer control module 108 may be configured to manage audible alerts that are triggered based on the computed protection factor value.

In some embodiments, the processor 38 may be configured to execute the exposure assessment application 98 and to communicate with a database 110 (e.g., an SQLite database) that is used to store validated sensor data locally on the processor 38. The database 110 may store information such as raw sensor measurements, computed protection factor values, and/or timestamps of operational records.

In some embodiments, the processor 38 may be further configured to execute a web server application 112, such as a Python-based Flask web server application which provides a communication interface between the exposure assessment application 98 and the one or more external client devices 18. The web server application 112 may be configured to receive queries from remote users and to transmit corresponding sensor data, protection factor values, system status information, and/or the like. In some embodiments, the processors 38 may be further configured to execute instructions that implement a Node.js server 114. The Node.js server 114 may also be used to assist with additional server-side processing or support for the web server application 112.

The client devices 18 may be configured to execute instructions of a web application 116. In some embodiments, the web application 116 may be implemented in JavaScript using ReactJS or a similar type of framework. The web application 98 116 may include a client-side JavaScript module configured to render the remote user interface in a web browser and a user interface 118 configured to display sensor data, protection factor values, and system alerts to remote users. The one or more client devices 18 may communicate with the PM exposure assessment device 12 via network 22 to access stored data and measurement data collected in real-time.

In operation, the processor 38 may receive sensor data from PM sensors 44-1, 44-2, 44-3 and may perform a cyclic redundancy check (CRC) to validate the sensor data. Validated sensor data may be stored using the database 102 and may be presented on the touchscreen-based local interface or transmitted to one or more client devices 18 via the web server application 104. Through this architecture, the PM exposure assessment device 12 provides both local and remote monitoring capabilities, enabling a user to receive real-time alerts, historical data, and protection factor values through multiple interfaces.

FIGS. 8A-8C illustrate various state diagrams associated with the software of the PM exposure assessment device 12.

FIG. 8A shows an example diagram of pages capable of being displayed on the user interface 24 of the PM exposure assessment device 12. The exposure assessment application 98 may initialize to an easy mode page 120 by default. Easy mode page 120 may provide the user with abstracted information about the protection factor value and/or qualitative information about ambient environmental concentration levels. From the easy mode page 120, the user can navigate to a settings page 122, an information page 124, and/or to an expert mode page 126, such as by selecting a corresponding tab from a tab bar displayed on the user interface 24. As shown, the exposure assessment application 98 may support state transitions between each respective page, enabling the user to switch freely between each page.

FIG. 8B illustrates an example state diagram of the easy mode page 120. While in the easy mode page 120, the processor 38 may determine whether a computed protection factor value is above, between, or below one or more selected threshold values. In the example shown, the one or more selected threshold values include an upper bound threshold value and a lower bound threshold value. When the protection factor value is greater than the upper bound threshold value, the exposure assessment application 98 enters a normal level state 128. When the protection factor value falls between the upper bound threshold value and the lower bound threshold value, the exposure assessment application 98 enters a medium level alert state 130. In this state, the PM exposure assessment device 12 may trigger an audible alarm. For example, an audible alarm may be triggered every three seconds and may cause the user interface 24 to flash yellow. When the protection value falls below the lower bound threshold value, the exposure assessment application 98 enters a high-level alert state 132. In this state, the PM exposure assessment device 12 may also trigger an audible alarm. For example, an audible alarm may be triggered every second and may cause the user interface 24 to flash red. The easy mode page 120 may also include an option to snooze the audible alarm. From any of the states, the exposure assessment application 98 may transition to an exit state 134 based on a command provided by the user.

In some embodiments, the settings page 122 allows the user to configure the upper bound and lower bound threshold values used in the easy mode page 120. These threshold values may be preset values associated with common respirator types or defined manually by the user. The thresholds shown are provided by way of example. In practice, any number of different ranges of threshold values may be implemented and the specific threshold values may be set based on the type of respirator being worn by the user. The information page 124 may display additional device-related information, including wireless network parameters, total system runtime, battery status, and/or the like.

FIG. 8C illustrates an example state diagram for the expert mode page 126. In the expert mode page 126, the exposure assessment application 98 may provide real-time reporting of protection factor values and/or ambient and/or environmental PM concentration levels. By default, the expert mode page 126 may display a real-time plot 136 of the total protection factor. Using navigation arrows, the user may transition between multiple real-time plots corresponding to protection factor values (shown using reference numbers 138-148) for different particle sizes (e.g., 0.3 micrometers (μm), 0.5 μm, 0.7 μm, 1 μm, 2.5 μm, and 5 μm) and plots corresponding to environmental PM concentrations (shown using reference numbers 150-154) for various particle sizes (e.g., PM 1, PM 2.5, PM 10, etc.). The example state diagram in FIG. 7C illustrates these options, showing transitions between the total protection factor plot 136, the series of protection factor plots categorized by size (reference numbers 138-148), and environmental concentration plots categorized by size (reference numbers 150-154). From any of these plots, the user may navigate back to the total protection factor plot 136 or may exit the exposure assessment application 98 via the exit state 134.

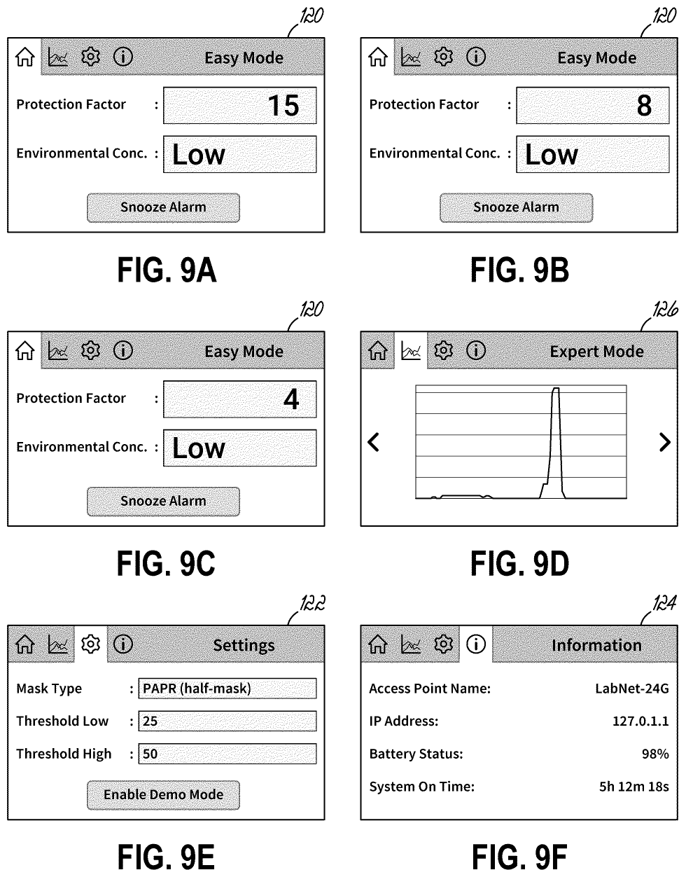

FIGS. 9A-9F illustrate example display pages of the exposure assessment application 98 as displayed on the user interface 24 of the PM exposure assessment device 12. As described above, the user interface 24 may provide multiple display modes and configuration options that allow a user to monitor protection factor values, environmental concentration levels, and/or other system parameters in real time.

As shown in FIG. 9A, the easy mode page 120 may display a calculated protection factor value and an ambient concentration level. The protection factor value may be computed based on sensor data received from PM sensors 44-1, 44-2 and the ambient concentration level may be provided via sensor data received from PM sensor 44-3. In the example shown, the protection factor value is displayed as “15” and the environmental concentration level is displayed as “Low.” A snooze alarm button is provided at the bottom of the page which permits the user to temporarily silence audible alarms.

The easy mode page 120 may further display the calculated protection factor value and/or the ambient concentration level in a selected color, such as green, yellow, or red, where the color corresponds to whether the protection factor value and/or the ambient concentration level is above or below a corresponding configured threshold value. In situations such as that shown in FIG. 9A, the protection factor value may be above an upper bound threshold value. In these situations, the calculated protection factor value and/or the ambient concentration level may be displayed in green.

FIG. 9B shows the easy mode page 120 when the calculated protection factor value falls between a high threshold value and a low threshold value. In this example, the protection factor value is shown as “8,” and the background color may be displayed in a different color, such as yellow, indicating a medium risk alert condition. In this scenario, the alarm may be triggered at a frequency (e.g., every three seconds) that is lower than a frequency corresponding to a high-risk alert condition to prompt user awareness.

FIG. 9C shows the easy mode page 120 when the calculated protection factor value falls below a lower bound threshold value. In this example, the protection factor value is shown as “8,” and the background color may be displayed in another color, such as red, indicating a high risk alert condition. In this scenario, the alarm may be triggered at a frequency (e.g., every second) that is higher than a frequency corresponding to a medium-risk alert condition to notify the user of an unsafe condition.

As shown in FIG. 9D, the expert mode page 126 may display a plot in real-time of the protection factor values captured as a function of time and displays both current and peak protection factor values. Navigation arrows are provided to allow the user to swipe between various plots corresponding to additional protection factor data (e.g., by particle size) or ambient concentration levels (e.g., PM1, PM2.5, PM10). This mode provides advanced users with granular data to analyze the protection factor and PM exposure trends in real time.

As shown in FIG. 9E, the settings page 122 may permit the user to select a mask type (e.g., a powered air-purifying respirator (PAPR) half-mask or another type of respirator). The user may also adjust or set one or more threshold values, such as a lower bound threshold value (e.g., 25) and an upper bound threshold value (e.g., 50). Additionally, a demo mode button may be selectable for training or evaluation purposes.

As shown in FIG. 9F, the information page 124 may provide system-related data, such as a wireless access point name (e.g., LabNet-24G), an internet protocol (IP) address (e.g., 127.0.1.1), a battery status indicator (e.g., 98% battery remaining), and/or a system-on-time value (e.g., 5 hours, 12 minutes, 18 seconds). This allows users or administrators to check device connectivity, monitor battery life, and determine system uptime.

### Experimental Results

A. Comparison of a PM Sensor (PMS) 11 Sensor with a TSI Optical Particle Sizer (OPS) 3330

In some embodiments, the PM sensors 44-1, 44-2 integrated into the PM exposure assessment device 12 may be low-cost TemTop PM sensors (PMS-11). The performance of these sensors may be evaluated against a high-accuracy reference instrument. A TSI Optical Particle Sizer (OPS) Model 3330 was selected as the reference sensor due to having high precision, reliance on the same optical scattering principle as the PMS-11, and having a sampling flow rate comparable to the PMS-11. For testing, sodium chloride (NaCl) particles were generated using a particle generator in a 24 m³ chamber room to create a controlled test aerosol environment. In addition to the PMS-11 sensors and the OPS-3330, a TSI P-Trak ultrafine particle counter (Model 8525), which employs a condensation particle counting technique, was used to monitor the ambient particle concentration within the chamber. During testing, the OPS-3330 and PMS-11 sensors were operated in parallel to sample and record PM concentration data under varying aerosol concentrations.

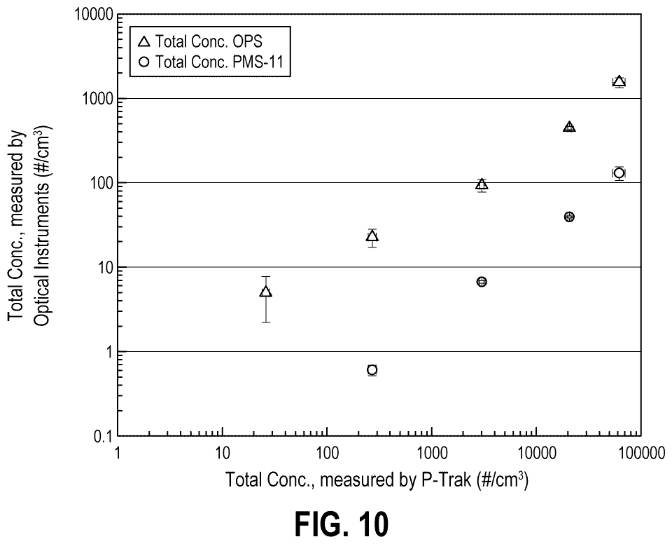

FIG. 10 compares the total levels concentration recorded from the PMS-11 and TSI OPS 3330 to the total concentration levels recorded from the P-Track. Each data point represents a one-minute average value with error bars calculated using standard deviation. As shown in the plot, the total concentration levels measured by Temtop PMS-11 is significantly less than TSI OPS 3330 while both follow the same trend. This is expected for any low-cost optical sensor and the data from the PMS-11 can be calibrated to match the reading from the TSI OPS 3330 sensor by scaling. However, calibration is not considered necessary for the intended application as the primary objective is to report fit factors which are calculated as a ratio of the PM concentration levels inside and outside of the respirator 16.

### B. System Current Measurement

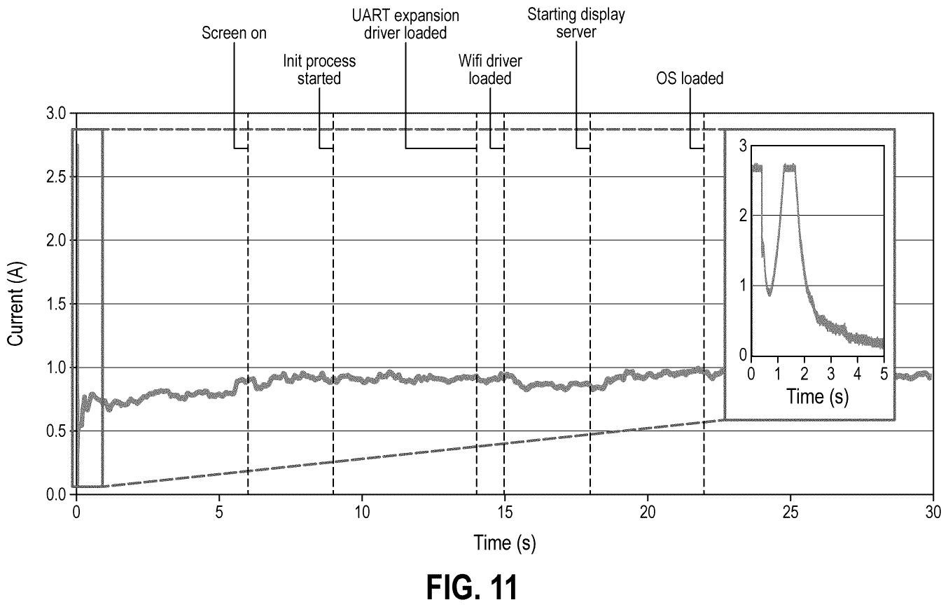

The total current consumption of the PM exposure assessment device 12, including both startup current and steady-state current, was measured using a Keysight N2821A probe. FIG. 11 shows a complete current profile and the right-hand side shows a transient startup current profile. The startup current profile shows initial current spikes reaching up to ≈2.7 A for ≈500 μs. This information is critical for calculating the necessary value for the buffer capacitor to compensate for these initial current spikes. Given that most battery packs available in small form factors have a maximum current rating of less than 2.4 A, incorporating a buffer capacitor is essential to handle these transient spikes. From FIG. 11, it can be observed that the steady-state current profile remains below 1 A.

### C. System Thermal Profile

The thermal characteristics of the PM exposure assessment device 12 were evaluated during continuous operation. The thermal profile was characterized using an infrared (IR) sensor (e.g., a Fotric IR camera) and thermocouple probes. The thermocouple probes were affixed to heat-generating components of the device, including the user interface 24 (e.g., a touchscreen), the processor 38 (e.g., Raspberry Pi Zero), and the airflow generators 46-1, 46-2 (e.g., miniature pumps). The PM exposure assessment device 12, enclosed within its 3-D printed housing, was operated under normal conditions for a duration of approximately 70 minutes.

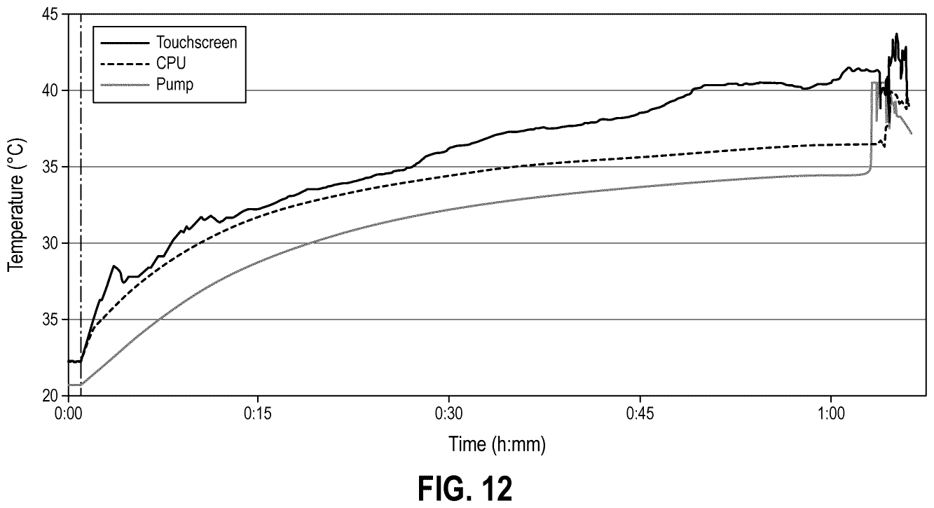

FIG. 12 illustrates the thermal profile data collected by the thermocouple probes over time. The x-axis of the graph represents elapsed time in hours and minutes (h:mm), while the y-axis represents the measured temperature in degrees Celsius (° C.). The figure includes three temperature traces corresponding to the monitored components: the touchscreen (the uppermost line), the processor or CPU (the middle line), and the miniature pumps (the lowermost line).

As shown, all three components exhibit a progressive increase in temperature during the initial operating period, eventually stabilizing after approximately one hour. The touchscreen demonstrated the highest operating temperature, exceeding 40° C., followed by the processor at approximately 37-38° C., and the miniature pumps at approximately 35° C. The test confirms that the touchscreen generates the most heat among the monitored components.

At the end of the 70-minute operating period, the device temperatures remained within acceptable operational ranges for each of the monitored components. In parallel, infrared thermal imaging of the opened device corroborated the thermocouple measurements, indicating localized heating primarily at the touchscreen. The overall maximum device temperature remained around 40° C., demonstrating that the device maintains stable thermal conditions during operation.

These results indicate that the PM exposure assessment device 12 does not require active cooling mechanisms (e.g., fans or heat sinks) under normal operating conditions. Instead, the passive thermal management achieved through the device design and component arrangement is sufficient to ensure safe and reliable long-term use.

### D. System Lifetime

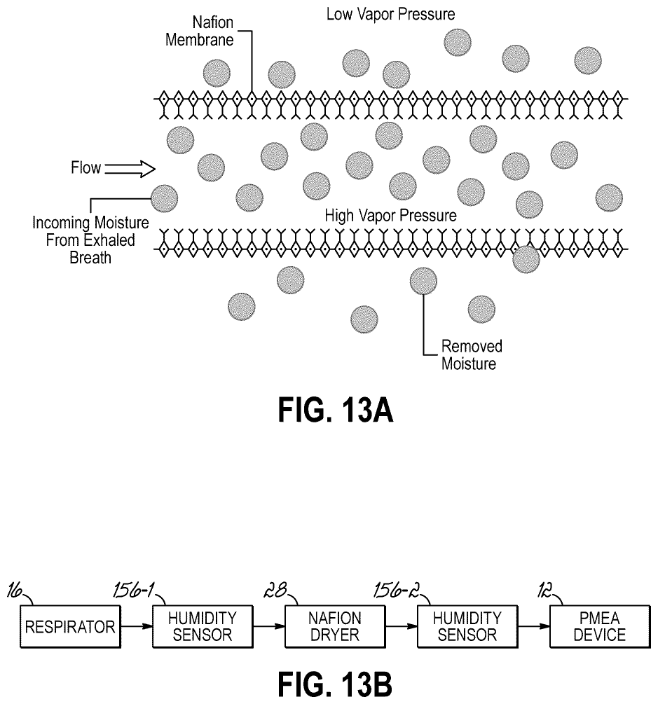

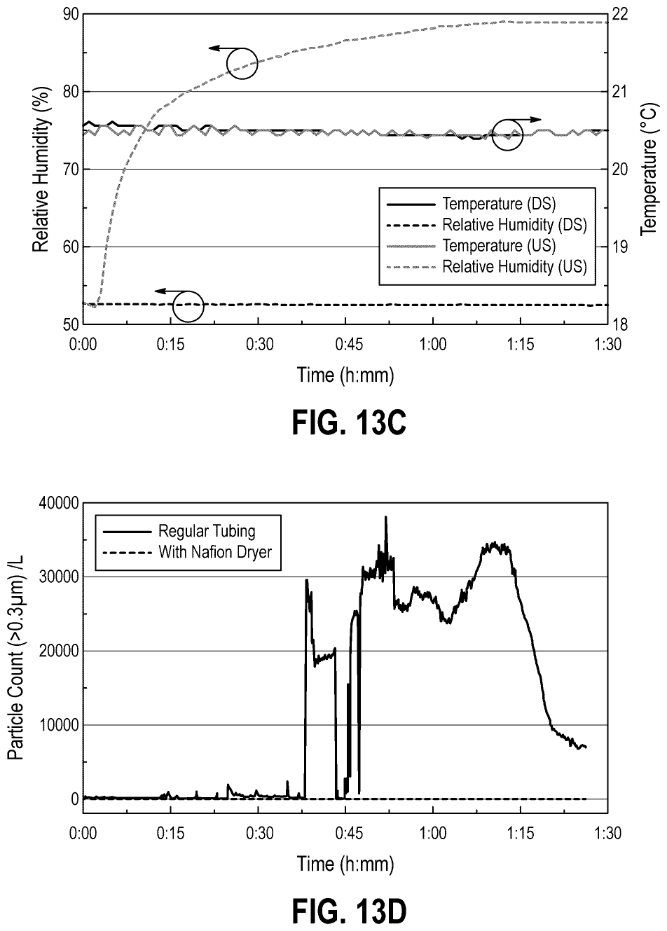

FIGS. 13A-13D illustrate experimental results associated with operational runtime of the PM exposure assessment device 12 and the effectiveness of a semi-permeable membrane tube 28 (e.g., a Nafion dryer) in controlling humidity levels within the PM exposure assessment device 12. During extended usage, the moisture present in exhaled breath can condense within a sampling pathway and interfere with sensor electronics. In the PM exposure assessment device 12, it was observed that condensed moisture from the exhaled breath interfered with particle sensor readings. After approximately 30 minutes of operation, the sensor connected to the respirator outlet would report anomalously high particle concentrations, even in controlled laboratory environments with low ambient particle levels. This issue of condensation is recognized as a common limitation among quantitative fit factor instruments that sample exhaled air. Commercially available fit factor instruments typically require the sampling tubes to be purged after approximately 30 minutes of use. Some commercial instruments employ heating strategies to delay condensation. However, manufacturers still recommend purging the tubing for extended durations of use as moisture eventually condenses. Prior research has also explored the use of water traps, but these proved inadequate, as liquid water could still reach and interfere with the sensor electronics.

To address the moisture condensation issue, various options were considered, with a semi-permeable membrane composed of Nafion identified as a solution. Nafion is a polymer composed of a Teflon™ backbone with occasional side chains of another fluorocarbon. Each side chain terminates with a sulfonic acid group (—SO₃H). The sulfonic acid groups enable Nafion to readily absorb water, in both vapor and liquid phases, and to selectively transport water vapor through the membrane. This transport is driven by the difference in humidity levels across the membrane, with the Nafion structure seeking to equalize the partial pressure of water vapor on either side. This property allows Nafion to act as an effective, highly selective semi-permeable membrane for water vapor, while maintaining the integrity of other gases or components within the system. The commercial availability in tubing form factors further facilitate integration into the PM exposure assessment device 12. The Nafion dryer can be positioned between the respirator 16 and the PM exposure assessment device 12 using tubing connections.

FIG. 13A illustrates the operating principle of a Nafion dryer, showing the selective removal of water vapor from exhaled breath as the water passes through the semi-permeable membrane 28. As shown, moisture from exhaled breath exhibiting a relatively high vapor pressure enters the semi-permeable membrane tube 28. The Nafion membrane selectively allows water vapor molecules to permeate through the walls. As a result, the vapor pressure inside the tubing is reduced while moisture is removed through the membrane to the lower pressure side. This reduces the amount of water vapor reaching downstream components of the PM exposure assessment device 12.

FIG. 13B illustrates an example device configuration for evaluating the effectiveness of the semi-permeable membrane tube 28 (e.g., the Nafion dryer). In this example, a respirator 16 was coupled to the PM exposure assessment device 12 through the Nafion dryer. An upstream humidity sensor 156-1 was positioned between the respirator 16 and the Nafion dryer to monitor incoming humidity levels. A downstream humidity sensor 156-2 was positioned between the Nafion dryer and the PM exposure assessment device 12 to monitor humidity levels after drying. This configuration enabled comparison of the humidity levels before and after the Nafion dryer during use. A test subject wore the respirator 16 for the duration of the evaluation.

FIG. 13C shows the recorded humidity and temperature profiles during the experiment using the Nafion dryer. The upstream humidity sensor 156-1 recorded relative humidity levels increasing rapidly and exceeding 85% within 30 minutes of use which is consistent with the accumulation of exhaled breath moisture. In contrast, the downstream humidity sensor 156-2 measured humidity values remaining stable near ambient conditions of approximately 50% relative humidity for the entire test period. The downstream temperature remained consistent, while the upstream temperature varied slightly with breath flow. These results confirm the effectiveness of the Nafion dryer in removing exhaled moisture and preventing high humidity conditions downstream.

FIG. 13D shows PM concentration readings obtained by testing regular tubing and comparing the test results to corresponding test results of the Nafion dryer. As shown, the particle count measured with regular tubing began to deviate and produce erroneous readings after approximately 30 minutes of use which corresponds to moisture accumulation within the tubing. In contrast, when the Nafion dryer was incorporated, the PM concentration remained stable and accurate throughout the entire test duration (>87 minutes). These results demonstrate that the inclusion of a semi-permeable membrane tube 28 (e.g., a Nafion dryer) significantly improves measurement reliability and extends the effective usage duration of the PM exposure assessment device 12.

While Nafion dryers are highly effective in environments with low ambient humidity, performance can degrade in high humidity conditions. In such environments, a desiccant membrane dryer may be substituted. For example, a desiccant-packed Nafion dryer, such as those commercially available from Perma Pure in cuboid form, may be used. Alternatively, custom tubing may be fabricated with desiccant material surrounding the Nafion membrane to maintain a dry environment for moisture removal.

E. Evaluation of PM Exposure Assessment Device 12 with Reference Instrument

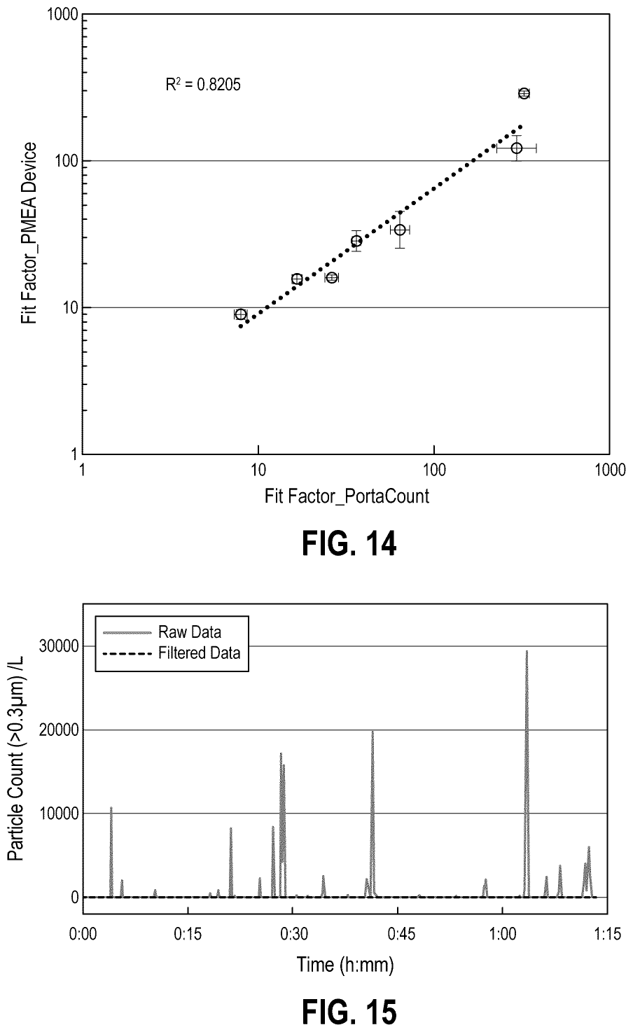

FIG. 14 illustrates a comparison between fit factors measured by the PM exposure assessment device 12 and fit factors measured by a commercially available quantitative fit testing device (e.g., a PortaCount® system). As shown, each data point represents a paired measurement of fit factors obtained simultaneously using the two devices. The plotted data demonstrates that the fit factors reported by the PM exposure assessment device 12 correlate strongly with the fit factors reported by the commercial fit testing system. This indicates that the PM exposure assessment device 12 can provide fit factor measurements consistent with existing industry-standard instruments. This comparison validates that the PM exposure assessment device 12 is capable of accurately reporting protection levels while enabling additional portability and real-time monitoring features not available in conventional systems.

### F. Effects of Coughing on Performance of the PM Exposure Assessment Device 12

The effect of coughing on the performance of the PM exposure assessment device 12 was evaluated. For this evaluation, a human test subject fitted with a respirator 16 (e.g., an N95 respirator) was connected to the PM exposure assessment device 12 while in a low PM concentration laboratory environment. During the 75-minute test, the subject was instructed to cough at random intervals.

FIG. 15 shows the PM concentration data recorded during the test. The uppermost line represents the raw data collected by a PM sensor 44. As illustrated, the raw data includes several spikes occurring throughout the test period. These spikes were not due to respirator leakage but instead were artifacts caused by coughing. Such anomalies can be distinguished based on their characteristic features, such as high amplitude and short duration as compared to signals arising from actual leakage events.

To address these anomalies, a filtering algorithm was implemented as part of the exposure assessment application 98 of the PM exposure assessment device 12. The filtering algorithm incorporates a moving average combined with a median filter, along with duration and amplitude threshold values to identify and remove spikes attributable to coughing. The lowermost line represents the filtered data output by the algorithm. As shown, the filter effectively suppresses the anomalous spikes in the raw data while preserving the underlying PM concentration trend, thereby improving the accuracy of the fit factor calculations.

These results demonstrate that the PM exposure assessment device 12, implemented as part of a low-cost portable real-time PM exposure protection system 10, is capable of continuously monitoring respirator fit factor while compensating for artifacts introduced by coughing. The system includes multiple user interfaces and audible/visible alarms to alert workers in the event of respirator leakage. Comparative testing against commercially available quantitative fit factor measurement systems has shown significant correlation, particularly when evaluated with powered air-purifying respirators (PAPRs). Furthermore, the integration of a semi-permeable membrane tube 28 (e.g., Nafion dryer) into the sampling tube 14-1 mitigates condensation issues that typically limit the usable duration of such devices. This extends operational time from less than thirty minutes to greater than eighty-seven minutes without requiring tube purging.

As shown below, Table I illustrates default threshold settings that may be used by the exposure assessment application 98 for various common respirator or mask types.

| | Threshold | Threshold |
|---|---|---|
| Mask Type | High | Low |
| N95 | 5 | 10 |
| PAPR (half-mask) | 25 | 50 |
| PAPR (full-face) | 500 | 1000 |
| SAR (half-face) | 25 | 50 |
| SAR (full-face) | 500 | 1000 |
| SCBA (full-face) | 5000 | 10000 |
| Custom | Custom | Custom |

In some embodiments, the exposure assessment application 98 allows a user to select a mask type from a pre-programmed list, each with corresponding “high” and “low” protection factor threshold values. In addition, a “Custom” mode may be provided in which the user can define and store user-specific threshold values. These default presets allow the PM exposure assessment device 12 to accommodate different respirator types without requiring manual calibration by the user, thereby improving usability and ensuring that the fit factor alerts are tailored to the expected protection level of the selected mask.

As shown below, Table II summarizes the main system performance parameters for the PM exposure assessment device 12.

| Parameter | Value | |
|---|---|---|
| Package size (fully assembled) | 18 × 11.7 × 5.2 | cm³ |
| Custom PCB size | 30 × 65 mm² (same as RPi0) | |
| Peak instantaneous system current | 2.75 | A |
| Average active system current | 1 | A |
| Battery capacity | 5000 | mAh |
| System lifetime (assume 66% battery | ≈3.3 | hours |

| | |
|---|---|
| capacity) | |
| Data collection frequency | Every 2 s (PMS-11), 1.5 s |
| | (PM-900M) |
| Wireless communication protocol | WiFi |

The fully assembled package may have approximate dimensions of 18×11.7×5.2 cm³, enabling compact portability. The PCB 52 may have a size of approximately 30×65 mm², matching the footprint of the processor 38 (e.g., the Raspberry Pi Zero), thereby permitting a stacked configuration to minimize space. The peak instantaneous system current may be approximately 2.75 A, while the average active system current during operation may be approximately 1 A. The PM exposure assessment device 12 may be powered by a rechargeable battery with a capacity of approximately 5,000 mAh which provides a calculated operational lifetime of approximately 3.3 hours when assuming 66% usable capacity under full load. The PM exposure assessment device 12 may be configured to collect sensor data at high frequency, for example, every 2 seconds for PM sensors 44-1, 44-2 (e.g., PMS-11 sensors) and every 1.5 seconds for the PM sensor 44-3 (e.g., a PM-900M sensor), to enable real-time monitoring and fit factor calculation. Wireless communication may be supported through a Wi-Fi protocol, thereby enabling data transmission between the processor 38 and client devices. These performance parameters ensure that the PM exposure assessment device 12 provides adequate battery life, sampling rate, and connectivity for practical deployment in occupational settings.

The foregoing disclosure provides illustration and description but is not intended to be exhaustive or to limit the embodiments to the precise form disclosed. Modifications and variations may be made in light of the above disclosure or may be acquired from practice of the embodiments.

Some embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc., depending on the context.

Certain user interfaces have been described herein and/or shown in the figures. A user interface may include a graphical user interface, a non-graphical user interface, a text-based user interface, etc. A user interface may provide information for display. In some embodiments, a user may interact with the information, such as by providing input via an input component of a device that provides the user interface for display. In some embodiments, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, and/or a combination of hardware and software. The actual specialized control hardware or software code used to implement these systems and/or methods is not limiting of the embodiments. Thus, the operation and behavior of the systems and/or methods were described herein without reference to specific software code—it being understood that software and hardware can be used to implement the systems and/or methods based on the description herein.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A device for assessing particulate matter (PM) exposure in a respirator, comprising:
a first PM sensor configured to measure a PM concentration level inside of the respirator;
a second PM sensor configured to measure a PM concentration level outside of the respirator; and
a processor communicatively coupled to the first PM sensor and to the second PM sensor, wherein the processor is configured to:
determine a ratio of the PM concentration level outside the respirator and the PM concentration level inside of the respirator,
determine a particulate exposure risk within the respirator based on whether the ratio satisfies at least one predetermined threshold value, and
provide a message indicative of the particulate exposure risk.

2. The device of claim 1, further comprising a first airflow generator configured to provide airflow through a sensing region of the first PM sensor and a second airflow generator configured to provide airflow through a sensing region the second PM sensor.

3. The device of claim 2, further comprising:
a first port fluidly coupled to the first airflow generator, the first port configured to receive a first sampling tube connected to the respirator such that the first airflow generator directs air from the respirator through the sensing region of the first PM sensor; and
a second port fluidly coupled to the second airflow generator, the second port configured to receive a second sampling tube with an end that is open to an environment external to the respirator such that the second airflow generator directs air from the environment through the sensing region of the second PM sensor.

4. The device of claim 1, wherein the at least one predetermined threshold value includes an upper bound threshold value and a lower bound threshold value, and wherein the particulate exposure risk is determined based on whether the ratio of the PM concentration level inside the respirator and the PM concentration level outside of the respirator is: (i) above the upper bound threshold value, (ii) between the upper bound threshold value and the lower bound threshold value, or (iii) below the lower bound threshold value.

5. The device of claim 1, further comprising:
a user interface configured to display at least one of:
a protection factor value indicative of the ratio of the PM concentration level outside the respirator and the PM concentration level inside of the respirator,
a representation of the particulate exposure risk, and
an alert associated with a protection status of the respirator.

6. The device of claim 1, further comprising a third PM sensor configured to: measure an ambient PM concentration level in an environment surrounding the respirator.

7. The device of claim 6, wherein the processor is further configured to:
compare the ambient PM concentration level with the PM concentration levels measured inside and outside the respirator, respectively, and
generate contextual information based on said comparison, the contextual information including at least one of: an indication of workplace air quality, an adjustment to the particulate exposure risk determined for the respirator, and data for tracking long-term exposure trends.

8. The device of claim 1, wherein the message indicative of the particulate exposure risk comprises at least one of: a visible alert on a touchscreen user interface, an audible alarm, or a notification transmitted to a remote device.

9. The device of claim 1, wherein the processor is further configured to communicate wirelessly with another device over a network, the other device being configured to display the message indicative of the particulate exposure risk.

10. A method for assessing particulate matter (PM) exposure in a respirator, comprising:
measuring, by a first PM sensor of a device, a PM concentration level inside of the respirator;
measuring, by a second PM sensor of the device, a PM concentration level outside of the respirator;
determining, by a processor of the device, a ratio of the PM concentration level outside the respirator and the PM concentration level inside of the respirator;
determining, by the processor, a particulate exposure risk within the respirator based on whether the ratio satisfies at least one predetermined threshold value; and
providing, by the processor, a message indicative of the particulate exposure risk.

11. The method of claim 10, wherein determining the particulate exposure risk comprises:
comparing the ratio with an upper bound threshold value and a lower bound threshold value, and
determining the particulate exposure risk based on whether the ratio is: (i) above the upper bound threshold value, (ii) between the upper bound threshold value and the lower bound threshold value, or (iii) below the lower bound threshold value.

12. The method of claim 10, further comprising:
receiving, by a third PM sensor of the device, an ambient PM concentration level in an environment surrounding the respirator; and
generating, by the processor of the device, contextual information based on a comparison of the ambient PM concentration level with the PM concentration levels measured inside and outside of the respirator, respectively, wherein the contextual information includes at least one of: an indication of workplace air quality, an adjustment to the particulate exposure risk, and data for tracking long-term exposure trends.

13. The method of claim 10, further comprising:
directing, by a first airflow generator of the device, air from inside the respirator through a sensing region of the first PM sensor; and
directing, by a second airflow generator, air from an environment external to the respirator through a sensing region of the second PM sensor.

14. The method of claim 13, further comprising:
regulating, by the processor, an airflow rate of at least one of the first airflow generator and the second airflow generator by providing a pulse width modulation (PWM) control signal based on a measured flow rate and a configured flow rate.

15. The method of claim 14, wherein regulating the airflow rate comprises:
generating, by the processor, a control signal corresponding to a duty cycle for the airflow generator;
receiving, by the processor, a feedback signal indicative of a rotational speed or airflow rate;
determining, by the processor, an error value as a difference between the configured flow rate and the measured flow rate; and
updating, by the processor, the duty cycle of the control signal based on the error value.

16. The method of claim 10, further comprising:
removing, by a semi-permeable membrane tube disposed along a sampling tube coupled to the respirator, water vapor from air collected from inside of the respirator prior to measurement by the first PM sensor.

17. The method of claim 10, wherein the message indicative of the particulate exposure risk comprises at least one of: a visible alert on a touchscreen user interface, an audible alarm, or a notification transmitted to a remote device.

18. An exposure protection system, comprising:
a respirator;
a device adapted to assess particulate matter (PM) exposure in the respirator, the device comprising:
a first PM sensor configured to measure a PM concentration level inside of the respirator,
a second PM sensor configured to measure a PM concentration level outside of the respirator, and
a processor communicatively coupled to the first PM sensor and to the second PM sensor, wherein the processor is configured to:
determine a ratio of the PM concentration level outside the respirator and the PM concentration level inside of the respirator,
determine a particulate exposure risk within the respirator based on whether the ratio satisfies at least one predetermined threshold value, and
provide a message indicative of the particulate exposure risk;
a first sampling tube connecting the first PM sensor with the respirator; and
a second sampling tube connecting the second PM sensor with environment external to the respirator.

19. The exposure protection system of claim 18, wherein a portion of the first sampling tube comprises a semi-permeable membrane tube adapted to remove water vapor from exhaled air before the air reaches the first PM sensor.

20. The exposure protection system of claim 18, wherein the processor is further configured to communicate wirelessly with another device over a network, the other device being configured to display the message indicative of the particulate exposure risk.
